(19) United States
(12) Patent Application Publication
(10) Pub. No.: US 2019/0258936 A1
(43) Pub. Date: Aug. 22, 2019

(54) Systems and Methods for Improved Generalization, Reproducibility, and Stabilization of Neural Networks via Error Control Code Constraints

(71) Applicant: Google LLC, Mountain View, CA (US)

(72) Inventor: Gil Shamir, Sewickley, PA (US)

(21) Appl. No.: 16/275,813

(22) Filed: Feb. 14, 2019

Related U.S. Application Data
(60) Provisional application No. 62/710,372, filed on Feb. 16, 2018.

(51) Int. Cl. G06N 3/08; G06N 3/04

(52) U.S. Cl. CPC G06N 3/084; G06N 3/04

(57) ABSTRACT

The present disclosure relates generally to machine learning. More particularly, the present disclosure relates to systems and methods for improved generalization, reproducibility, and stabilization of neural networks via the application of error control, modulation, and/or lattice code constraints during training.

### PRIORITY CLAIM

The present application is based on and claims priority to U.S. Provisional Application 62/710,372 having a filing date of Feb. 16, 2018, which is incorporated by reference herein.

### FIELD

The present disclosure relates generally to machine learning. More particularly, the present disclosure relates to systems and methods for improved generalization, reproducibility, and stabilization of neural networks via the application of code constraints during training.

### BACKGROUND

Training neural networks using convex optimization techniques imposes challenges due to the non-convexity of the objective optimized. Non-convexity is the result of non-linearity and information propagation through the neural network. Gradient-based methods may suffer from instability or irreproducibility of the results because they may converge to local optima, and may not be able to exit such optima.

As a result, training the same network on the same training data may yield different results due to different random initializations, parallelization of training, and different schedules in which the training examples are seen. Thus, two identical networks trained on the same data set can diverge from one another in their predictions. This problem limits utilization of neural networks despite their usual superiority to linear models and other techniques.

A different interpretation to irreproducibility is in the redundancy that exists in the neural network. Multiple nodes and multiple node constellations can explain the same information in the training data, and initialization, parallelization and scheduling of training examples can lead the network to different explanations of the same data due to this redundancy.

Ensembling techniques have been shown to reduce these issues of stability and irreproducibility. Generally, ensembling of identical networks trained independently averages out initial conditions, parallelization, and scheduling effects to produce a form of convexification over the effects of these attributes on the objective, generating an objective that is more convex, and that is smeared over the uncontrolled parameters of initialization, scheduling, and parallelization.

Ensembling techniques, however, require duplicating the neural network multiple times and training and deploying each duplication of the network. For large networks trained over very large training sets, this is costly both in memory and CPU resources, both in training and deployment. As such, ensembling techniques are in some instances infeasible in huge scale systems due to lack of sufficient resources.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example co-distillation process with three towers with logistic loss.

FIG. 2 depicts a graphical diagram of an example coded-regularization on neuron weights at the top of each of three towers before conversion to labels.

FIG. 3 depicts a graphical diagram of an example coded-regularization process on neurons of a second layer of a neural network with rectified linear activations using a Hamming code for coded regularization.

FIG. 4 depicts a graphical diagram of an example coded-regularization process where the top activations are constrained to be equal, and the top hidden layer is constrained by a parity check matrix.

FIG. 5A depicts a block diagram of an example computing system that trains neural networks according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to systems and methods that regularize and constrain a neural network by leveraging the concept of code constraints such as constraints based on error correcting codes (ECCs) and/or modulation codes and/or lattice codes. In particular, in some implementations of the present disclosure this concept is applied by projecting the weights of neurons in hidden layers onto the null spaces of parity check matrices or onto some other linearly-constrained subspace. One effect of the constraints is to produce more stable and more reproducible networks robust to initialization, parallelization, and variations in training schedules. In particular, the imposed constraints can force a sparser set of local optima when subject to the constraints, essentially increasing the chance that independent training of the same network on the same data will converge to the same optimum. Further, in some implementations, the dimensionality of each layer can be increased (e.g., slightly increased) to alleviate possible objective losses due to the additional constraints, although, in some instances, the constraints will just reduce redundancy that already exists in the network without causing objective losses. In some implementations, the constraints can be applied through the training of the neural network as additional constrained gradients injected into the network. Some of the example approaches described herein extend on constrained optimization techniques, and generalize on co-distillation.

One effect of the techniques described herein is reduced consumption of resources in deployment and training. In particular, unlike other constraint optimization methods, in some implementations of the present disclosure the constraints can be applied directly to the structure of the network, and not on training examples. Further, unlike other ensemble methods that require deploying multiple copies of the network for prediction, in some implementations only a single copy of the network is trained and deployed. In training, constraints can be applied more efficiently so that training can commence with fewer resources (e.g., as opposed to standard ensemble methods). As one example, matrices used for parity check of (regular) Low-Density-Parity-Check (LDPC) codes can be used for generating balanced constraints. However, other code types can also be additionally or alternatively used to specify and apply constraints. In some implementations, constraints can be applied on individual hidden layers at the neuron and/or at the activation levels. Additionally or alternatively, constraints can be applied over interlayer nodes. As one example, the constraints can be applied on a narrow top layer.

Thus, according to aspects of the present disclosure, error correcting codes, modulation, lattices, or modulation codes can be used to constrain either neurons or other parameters in a deep network. For example, code constraints can be applied on neurons in a single layer or multi-layers, pre or post activation, and/or on weights of links and biases in a network. The neural network can be a deep network, and can be any type of deep network, including convolutional networks, recurrent neural networks, or other forms of neural networks.

According to another aspect, the code constraints can be applied through additional loss whose gradient is injected into the network in back-propagation. As examples, the additional loss can be added as a regularization term or via performance of Lagrangian constrained optimization. In some implementations, imposing the constraints can involve computation of a syndrome based on the code parity check matrix, which determines the propagated gradient. The loss applied can be proportional to a norm of the syndrome or some distance of the syndrome from some bias vector.

In some implementations of the present disclosure, standard error-control codes can be used, including block codes, convolutional codes, cyclic codes, and/or quasi-cyclic codes. The error-control codes can be used to apply constraints on a single layer, on multi-layers, on weights of network links, and/or weights of biases. Codes that have properties of perfect code, MDS codes, and other properties can be used.

Alternatively or additionally, modulation techniques, modulation codes, and/or lattice codes can replace classical error control codes to apply constraints on reals instead of finite fields domain.

More generally, any specific codes can be used, including, as examples, Hamming codes, Hadamard codes, BCH codes, LDPC codes, convolutional codes, turbo codes, LDGM codes, HDPC codes, Reed-Solomon codes, Reed-Muller codes, CRC codes, Golay codes, Polar codes, and/or other codes.

In some implementations, codes can be modified to apply to real numbers, for example, by changing the domain of the parity check matrix from a finite field. Some example modifications include, but are not limited to, negation of some entries, multiplication of nonzero entries by random numbers, and/or addition of random values.

According to another aspect, parity constraints can be imposed. For example, the constraints can sum to 0 or any other real number.

According to yet another aspect of the present disclosure, a rateless method can be applied where constraints are added as needed to improve generalization and reproducibility as long as performance is not degraded.

In some implementations, code constraints are applied within a single network. In other implementations, code constraints can be applied across multiple separate networks to improve diversity.

As another example, code constraints can be applied across an input embedding layer of a network if the input consists of an embedding layer. In some cases, even if input does not consist of embedding, code constraints can be applied on the input layer, also through lossy compression of the layer.

According to another aspect, the systems and methods of the present disclosure can puncture a neural network applied to break symmetry among network components. For example, puncturing a network can include dropping out certain of the links of the network.

According to another aspect, the systems and methods of the present disclosure can perform training example drop out from subsets of the network. Alternatively or additionally, the systems and methods of the present disclosure can shuffle (interleave) examples between parts of the network. These drop out and/or shuffling techniques can be applied to improve code diversity.

According to another aspect, standard error control decoding techniques can be employed to enforce constraints when training with parallel workers, each training a subset of the training examples. For example, a centralized process can apply error correction to enforce the constraints on the network when joining all updates.

Furthermore, according to yet another aspect, standard error corrections can be used to enforce constraints when retrieving the network from unreliable storage devices. These methods are more straightforward when imposing constraints on actual network parameters (link weights and biases), but can also be applied with validation data set when imposed on neurons (pre or post-activation).

In addition, constraints can be merged into hardware quantization requirements and enforce the network training solutions to satisfy these deployment or storage requirement. This can be performed, for example, when constraints are imposed on parameters (e.g., link weights and biases) with validation data sets on neurons (e.g., pre- or post-activation)).

Thus, the present disclosure provides systems and methods that use code constraints during training to improve the generalization, reproducibility, and stabilization of neural networks, thereby improving the performance, accessibility, and usability of neural networks.

In particular, aspects of the present disclosure reduce or eliminate the need or reliance upon ensembling techniques, which require duplicating the neural network multiple times and training and deploying each duplication of the network. For large networks trained over very large training sets, ensemble techniques are costly both in memory and CPU resources, both in training and deployment. Thus, by eliminating the need to use ensembling techniques, the present disclosure provides technical benefits in reduced consumption (e.g., savings) of both memory and CPU resources, while also providing models that exhibit enhanced performance.

### Introduction to Coded-Regularization

As described above, the general idea of distillation is to duplicate the beliefs of a complex (possibly redundant) model with a simpler model in the following manner: The complex model trains on the training data, whereas the simpler model trains on the beliefs of the complex model, and tries to duplicate the complex model.

A new approach called co-distillation, which is based on the distillation technique, addresses some of the drawbacks of the distillation technique. Co-distillation takes the distillation process further: Instead of having a complex and a simpler model, each model included in a group of models (potentially identical, but not necessarily) trains on the training data, but is also forced to partially train on the beliefs of the other models in the group. In other words, while the model trains on the training data, it is also constrained or regularized by the predictions of the other models.

When applying a gradient method in training, the gradient on the objective of the actual training examples is supplemented by a (scaled down) gradient obtained with the prediction of the other model(s). The scaling down provides a level of regularization, weaker than the actual top level objective that is being optimized. The overall optimization commences on the composite objective for each model in the set.

The general idea of co-distillation can be viewed as a mechanism of distilling (or teaching) the knowledge gained by one model in the set to the other models. While internally the models can differ (even if they share an identical topology), their overall predictions, or beliefs, are propagated back and forth among them, and the models converge to the same belief on the top labels.

Co-distillation, however, can also be viewed as some form of a constraint. The models are constrained to converge to a point in which they agree with one another, overall constraining the solutions which are acceptable to a smaller set than the set of all local optima of a single network. This also allows deployment of only a single model, or at least a smaller subset of models than the original set on which training was performed, because the models converge to a consensus optimum.

Aspects of the present disclosure take the co-distillation concept even further. In particular, co-distillation between two models can be viewed as a repetition code, where we repeat two copies of the neural network for the same task, and decode to a point where the networks (or code components) agree. With multiple models, this extends to multiple repetitions or parities between network pairs, as described below.

Taking this view even further, decoding of co-distillation resembles the mechanism used to decode error correcting turbo codes. The classical setting of error correcting turbo codes takes transmitted data through an FIR-like convolutional code to generate one set of parities. Then, the data is mixed by an interleaver and taken through the same convolutional code to produce another set of parities. Puncturing is used to achieve a desirable code rates. Decoding applies an algorithm that decodes one of the codes, generates beliefs for the original bits from that code, and passes these beliefs to the other code for decoding. The other code, now, decodes the data to a consensus point between the likelihoods it receives independently and the beliefs of the first code it receives. This process is applied back and forth between the subcodes until they agree on the original sequence. Co-distillation appears to perform an analogous process when attempting to converge to an optimum on which all components agree.

As recognized by the present disclosure, the connection between decoding of turbo codes and training in co-distillation implies that co-distillation can be viewed as a special case of a more general technique, which is referred to herein as coded-regularization. As described, if the ensemble of codes is viewed as one network, co-distillation can be viewed as a set of parities on output at the top layer connecting all the top level nodes, where a belief propagation-like approach is used to decode this set of parities. Networks trained according to the coded-regularization technique can be referred to as Code-Constrained-Deep-Networks.

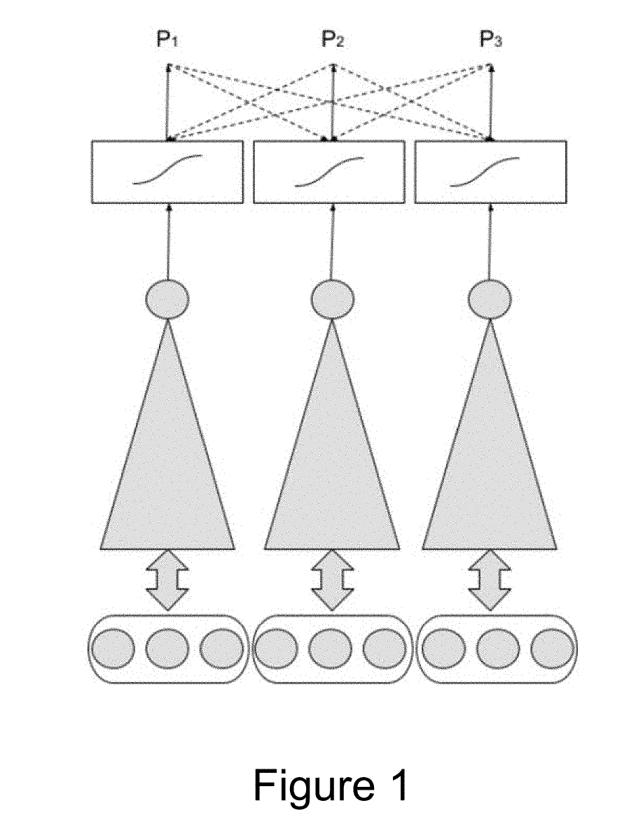

As one simplified example, FIG. 1 shows three networks that are joined in their outputs. The prediction of each node can be fed back to the others in back-propagation (e.g., with some down-scaling factor) to update each of the networks. The dashed arrows demonstrate feeding the label predicted by each of the networks to the two other networks while training. This is done for the predicted label. In case of binary logistic-regression, this label can be a fractional label, representing the predicted probability of a positive label by the respective network.

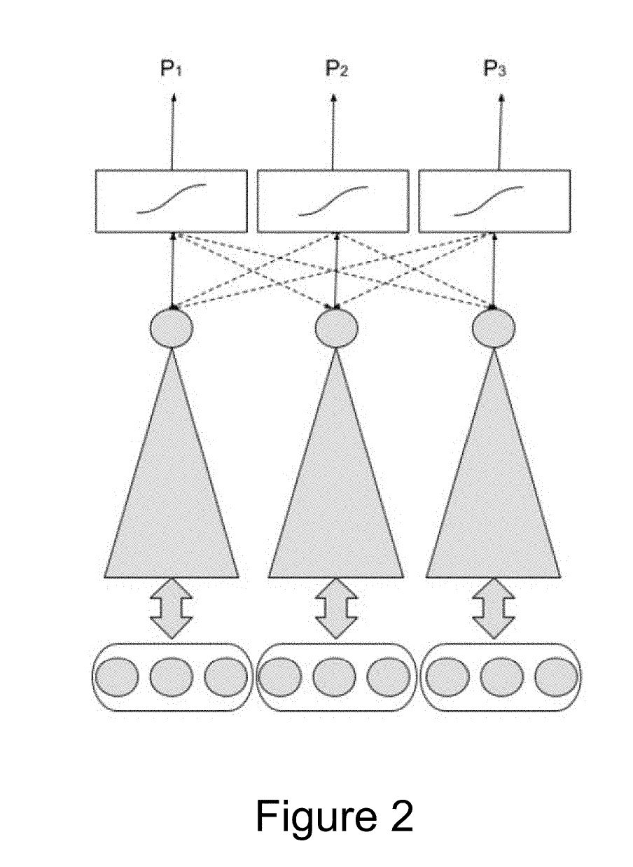

However, as recognized by the present disclosure, a similar process can be applied before an output is converted into a label, on the weights (log-odds in case of logistic regression) produced by each of the networks (or towers) on the top neurons before they are converted to probability or any other type of label, as shown in FIG. 2. In particular, the co-distillation operation can be brought down to the neuron level prior to conversion of the predicted value into a label. Instead of propagating the gradients of the label produced by any of the component networks, the propagation can be applied on some loss of the weight relative to the combination of weight values produced from the other component networks.

When lowering the comparison of the predictions to the neuron weights' level, one can now view co-distillation as a set of parities, essentially comparing the weight produced at the neuron at the top of each tower (representing a respective network) to that produced at the top of any of the other towers, before the weights are converted to labels.

According to an aspect of the present disclosure, the top layer of the combination of the three networks shown in FIG. 2 can be viewed as if it is constrained to satisfy three parity check equations (e.g., over the real values of neuron weights) described by the parity check matrix:

$$H = [ \begin{matrix}1 & - 1 & 0 \\ 1 & 0 & - 1 \\ 0 & 1 & - 1\end{matrix} ]$$

This is because applying co-distillation generally tries to make the output of tower 1 equals those of towers 2 and 3, and also that of tower 2 equals that of tower 3. In other words, constraining pairs of weights in the top layer to be equal imposes a constraint on the top layer (that combines the three towers) that the layer weights must be on the projection of R³ onto the null space of the matrix H. Essentially, this can be viewed as trying to minimize the error vector s between the parity check over the neuron weights and some constant bias vector c (which here is 0), i.e.,

s=H·z−0

where z is a column vector representing the neurons at the top of the towers. Using the terminology of error correcting codes, the syndrome s is used to represent the error vector. The matrix H is an [n×(n−k)] parity check matrix, where n is the number of neurons in the layer, and k, k≤n; is the dimension of the code. Note that in the above example the dimension of H is 2 and not 3, as the three equations are linearly dependent.

The idea described above can now be made more general, and the present disclosure refer to this generalized idea as coded-regularization. In particular, instead of having just parity equations that force top level neurons of two towers to be equal for pairs of towers, sets of parity check equations can be applied for one or more (e.g., each) of the hidden layers of a neural network of any architecture (including a fully connected one), not only the top layer(s). In fact, linear constraint equations can be applied to any inner node, weight, and/or bias of the network, and to either the neurons and/or the activations of the neurons. Example methods to implement this concept are described below when applied to the neurons at some layer of the network, but the same method can be applied in different levels of the network.

The name coded-regularization is used because the approach uses codes to distill information (or constraints) among components of the network, which can result in improved regularization. In particular, in some implementations, the neuron vector in a layer can be constrained to the null space of H if the constraints are homogenous (c=0). With constraints that are not homogenous, the neuron vector is projected to some shifted subspace determined by the null space of H. This forces the neural network to be constrained to a subset of solutions for the layer, potentially sparsifying the solutions, and making it harder for the network the reach different solutions when trained independently on the same set of examples.

This can be viewed as if the optimal solution is being constrained to be on planes slicing the objective function that is being optimized. This can, in some instances, result in omitting a global optimum from the set of constrained solutions. However, by increasing the dimensionality of the solution space for the layer, the global optimum can be included in the possible solution space. Further, by using the code, and imposing planes, the solution can be made convex in the constrained space formed by the planes that impose the constraints. As in error control codes, these techniques effectively increase some notion of a distance between elements in the constrained solution space, potentially isolating the global optimum in this space, and making it more accessible.

In some implementations, some (n−k) of the nodes in the layer become redundant nodes whose purpose is to create the effect described. This may result in the network performing as well as an identical unconstrained layer with k nodes, but improve the reproducibility when retraining the same network with the same training data. In some instances, this will not even degrade performance of a network with the same number of nodes in a given layer, as the constraints may just rearrange the redundancy that already exists in each layer. This redundancy can, in fact, be the reason for irreproducibility and the constraints may enable arranging it in a more reproducible manner.

The selection of the code H will affect the performance. A Hamming code can be used with small redundancy in a layer. Lower rate codes can also be used. Specifically, one can use Low-Density-Parity-Check (LDPC) codes and randomly select a parity check matrix H that imposes a set of n−k parity equations on n nodes of the layer (reducing the dimensionality of the space spanned by the layer from n to k). In some implementations, the dimensionality can be increased by increasing n if necessary. Unlike standard error correcting codes, the math can be applied on the reals and not in finite fields. There is no constraint to force the parity equations to equal 0. Instead, an n−k dimensional vector c can be elected, to which the product is constrained to equal. Note that this also dictates a design decision. If c is constrained to be the 0 vector, in cases where activations are given by rectified linear units, the constraints can be applied only on the activations if the matrix H is allowed to include negative values. If the parity-check-matrix H is kept binary, when using rectified linear units for activation, one can apply the constraints on neuron values produced before the activation is applied if a homogeneous constraint is imposed. As shown later, the choice of the parity check matrix for a specific code together with learning rate parameters also do have impact on the convergence rate performance.

Thus, the present disclosure provides techniques which combine ideas from Error Correcting codes into training of a neural network. It imposes constraints on the topology of the network, but not on the training examples. This is unlike any other techniques used in the literature. It does not use ensembles and does not require increased resources for training and deployment.

Next, the constraints will be formally defined. Let z^{l} be a column vector of length n^{l} representing the n^{l} neurons in level l of the neural network for training example t. Let H^{l} be the imposed parity check matrix in level l of dimension (n^{l}−k^{l})×n^{z} and let c^{l} be an imposed bias column vector in level l of length n^{l}−k^{l}. Then, the syndrome

s^{l}=H^{l}·z^{l}−c^{l}

represents the value of the constraint on the neurons at level l, which can be constrained to be 0. For convenience, the superscript l is omitted in the following description. The subscript t representing the training example is also omitted for both the syndrome s and the neuron vector z (unless it is necessary for context).

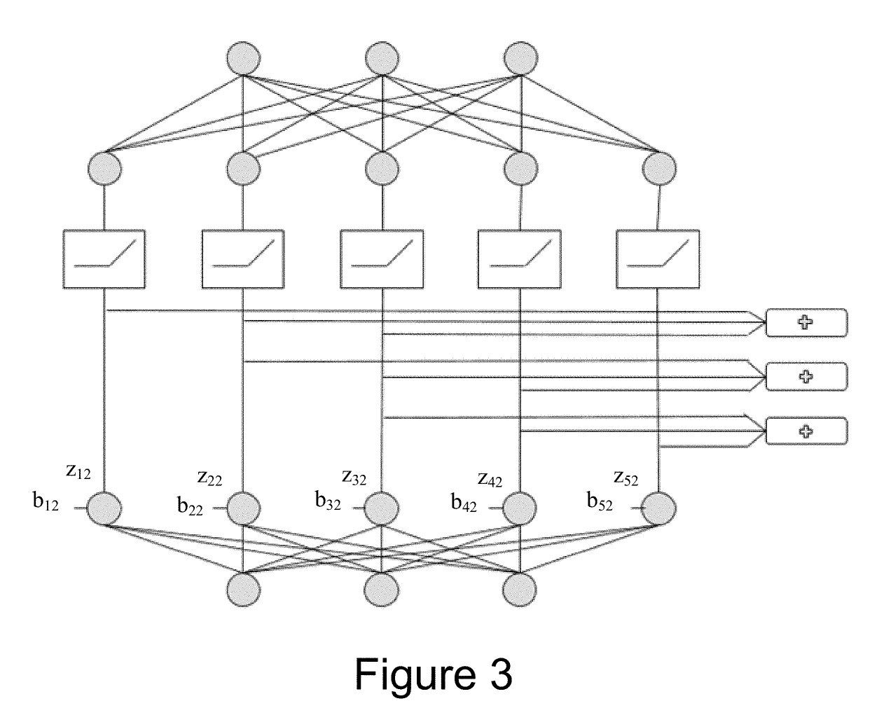

FIG. 3 demonstrates an example code constraint on the neurons of the second layer of a neural network. The example matrix applied is

$$H = [ \begin{matrix}1 & 1 & 1 & 0 & 0 \\ 0 & 1 & 1 & 1 & 0 \\ 0 & 0 & 1 & 1 & 1\end{matrix} ]$$

According to an aspect of the present disclosure, in some implementations, code constraints can be applied as additional loss constraints on layers of a neural network. To force the constraints, they can be injected in the backward step of back-propagation when the full objective gradient is propagated down in the network.

In one example, the constraint can be imposed by imposing L₂, regularization terms for each equation in the set of equations described by the matrix equation above. As another example, the constraint can be imposed by applying Lagrange constrained optimization minimizing the loss with respect to (w.r.t.) z^{l} but maximizing it w.r.t. a multiplier dual variable vector λ^{l} of length n^{l}−k^{l}. This can be done on each layer of the network on which such a constraint is imposed. Example implementations of the two methods are described below.

### Coded-Regularization with L₂ Like Regularization

One example method to impose the linear constraints of the code applied on the neurons of a layer is to add a loss component of the square error of the constraint to the composite loss seen at layer l. This can be added in a form of L₂ like regularization, where the whole set of equations is considered a single L₂ constraint. The constraint strength relative to the top level objective is controlled by a single scalar A. Alternatively, each row of the parity check matrix H and bias vector c imposing a constraint can be considered as an independent constraint. The strength of each constraint row can be controlled by a component of a constraint strength vector:

λ=(λ₁,λ₂, . . . ,λₙ₋ₖ)^{T}.

Scalar L₂ Constraint:

Let Lₜ denote the loss for the high-level objective obtained when training on example t. Define \tilde{L}ₜ as the composite loss at layer l, (recalling that the layer superscript is omitted for convenience). The composite loss can be the superposition of the high-level objective loss and the additional loss imposed by the constraint at layer l. Note that this is a slight abuse of notation, because Lₜ also includes constraint losses of other higher layers. Then, the composite loss can be expressed as

$${\tilde{L}}_{t} = {L}_{t} + \frac{λ}{2} {s}^{T} \cdot s$$

Differentiating w.r.t. the neuron vector z, the gradient w.r.t. the neuron weights is given by:

$$\frac{\partial {\tilde{L}}_{t}}{\partial z} = \frac{\partial {L}_{t}}{\partial z} + λ [ {H}^{T} Hz - {H}^{T} c ]$$

where the expression for the syndrome s was substituted, and H^{T} denotes the transpose of the matrix H. This implies that the gradient of the loss propagated down during backpropagation from the neurons z will be the sum of the gradient computed for z from the layers above with the additional constraint imposed term:

λ[H^{T}Hz−H^{T}c].

The products H^{T} H and H^{T} c can be computed once in advance and used throughout the whole training. Specifically, with homogenous constraints (c=0), the [n×n] dimensional product λH^{T} H can be precomputed in advance and applied at any update of the layer throughout backpropagation.

Energy and Learning Rate Constraints:

It is reasonable to hypothesize that a total measure of energy of each constraint, represented by a row of H and a respective component of c, should be equal. In other words, either the L₁ or L₂ norm of all rows for H should be equal, and thus the vectors constituting these rows should be normalized. This will dictate symmetry across the different constraints. However, in some instances this may not be the case, and having constraints that dominate others may actually speed convergence in a certain direction. Since the elements of H affect the updates linearly, in some implementations, an L₁ constraint can be used instead.

The rows of H describe the n−k constraints. The columns determine the update applied to each neuron. Normalizing H^{T} over the columns of H will constrain each neuron to be updated with an effective equal learning rate. In instances in which imposing equal learning is desired, matrices that satisfy this property can be selected, and/or H^{T} can be replaced by a version that is normalized across the columns.

The energy constraints described above demonstrate that not only the code but the form of the parity check matrix that represents the code will affect performance through controlling the rate in which the constraint is trained together with the learning rate used in training.

As an example, consider the standard [7, 4] Hamming code

$$H = [ \begin{matrix}0 & 0 & 1 & 0 & 1 & 1 & 1 \\ 0 & 1 & 0 & 1 & 0 & 1 & 1 \\ 1 & 0 & 0 & 1 & 1 & 0 & 1\end{matrix} ] .$$

It is easy to see that a row energy constraint is satisfied. However, in the real field (as opposed to the finite field GF(2)) the column energy constraint required so that all neurons are updated at the same rate, is not satisfied. This is because some neurons are included in one constraint, while others are included in two or more. Therefore, the (first) parity code neurons are updated with one constrained gradient, while the systematic (last) neurons are updated with gradients from more than a single parity check.

In some implementations, it can be assumed that the code is systematic, where the last neurons (four in the example above) are equal to the original non-redundant “message”, and the first three neurons in the example above are constrained parity neurons. This need not necessarily be the case, and the actual situation depends on the generator matrix.

Thus, all neurons can be updated at the same rate, or some neurons can be updated faster than others so that they then push the others to the correct solution. The fact that neurons that are included in more parity checks will take gradient updates from more neurons is illustrated by the n×n dimensional matrix H^{T} H for the [7,4] Hamming code

$${H}^{T} H = [ \begin{matrix}1 & 0 & 0 & 1 & 1 & 0 & 1 \\ 0 & 1 & 0 & 1 & 0 & 1 & 1 \\ 0 & 0 & 1 & 0 & 1 & 1 & 1 \\ 1 & 1 & 0 & 2 & 1 & 1 & 2 \\ 1 & 0 & 1 & 1 & 2 & 1 & 2 \\ 0 & 1 & 1 & 1 & 1 & 2 & 2 \\ 1 & 1 & 1 & 2 & 2 & 2 & 3\end{matrix} ]$$

While over GF(2) the total weight of each row would be equal, over the reals, the gradients of the first three (parity) neurons are updated as linear combinations of four neurons. The gradients of the next three systematic neurons are updated as linear combinations of six neurons, where two are upweighted, and the gradient of the last neuron is updated by a linear combination of all neurons, where systematic neurons are upweighted.

As mentioned, in some implementations, to preserve equal energy among rows, H can be replaced by a matrix whose rows are normalized, and H^{T} by the transpose of a matrix whose columns are normalized. Regular LDPC codes, such as the (3,6) code satisfy the property that the row weights are equal for all rows and the column weights are equal for all columns. Such codes can be used, but may impose many constraints (the (3,6) code is a rate ½ code).

Batch Training:

The backpropagation gradient updates described above can be performed per training example. However, they can also be aggregated over a batch of examples with summation of right hand side layer update terms over all examples in the batch. Specifically, the terms of the code constrained gradient λ[H^{T} Hz−H^{T} c] can be summed over the examples in the batch, where zₜ can differ between different examples in the batch.

Vector L₂ Constraint

In some implementations, when the rows of H have unequal energy, different regularization strengths can be used for each row. Instead of regularizing with a scaler λ, a vector λ . . . (λ₁, λ₂, . . . , λₙ₋ₖ)^{T} of regularization strengths can be used, where each component is applied to its equation. The composite loss can be expressed as

\tilde{L}ₜ=Lₜ+½s^{T}Λs,

where Λ=diag(λ) is a diagonal (n−k)×(n−k) dimensional matrix, whose diagonal elements are the components of λ. Then, the gradient of the composite loss w.r.t. z is given by

$$\frac{\partial {\tilde{L}}_{t}}{\partial z} = \frac{\partial {L}_{t}}{\partial z} + [ {H}^{T} ΛHz - {H}^{T} Λ c ] ,$$

where, again, the n×n dimensional matrix H^{T} ΛH and the n dimensional vector H^{T} Λc can be precomputed. Backpropagation can be performed by replacing the top level loss gradient propagated into z by it sums with the rightmost elements of the right hand side of the equation.

### Coded-Regularization with Lagrange Constraint Optimization

A different approach to impose the code constraints on a layer of the neural network is by applying Lagrange constrained optimization minimizing the loss w.r.t. the set of neurons in each of the examples zₜ but maximizing it w.r.t. a multiplier dual variable vector of length n−k, λ. Since this optimization is applied sequentially over the set of examples, the subscript t is not omitted from the neuron vector in the description below.

Lagrange Constraint Optimization

Similarly to the constraint optimization w.r.t. the bias of selected features, the optimization problem is to find the neuron vector zₜ that at some time point minimizes the composite loss objective, and the constraint vector λₜ that maximizes the composite loss

$${max}_{\underline{λ}} {min}_{z} \{ {\sum }_{t} [ {L}_{t} + {\underline{λ}}^{T} ( H \cdot z - c ) ] \} .$$

This optimization yields the following updates per example of the neuron and constraint vectors:

$$\frac{\partial {\tilde{L}}_{t}}{\partial {z}_{t}} = \frac{\partial {L}_{t}}{\partial {z}_{t}} + {H}^{T} \underline{{λ}_{t}}$$

where both vectors in the update equations are functions of the current update time. Carrying the update over to the neural network, the backpropagation gradient of the neuron weight variables will be the sum of the propagated gradient from the above layers and the additional constrained gradient term H^{T} λₜ. The dual variable update is given by

$$\frac{\partial {\tilde{L}}_{t}}{\partial {\underline{λ}}_{t}} = {Hz}_{t} - c .$$

There is no gradient value passed to the dual variable update from the layers above, as it is a constraint for the specific layer.

The backpropagation gradient updates described above are performed per training example. However, as described for the L₂ regularization based approach, the updates can be applied to all examples in the batch together, where quantities like H^{T} λₜ and c are weighted by the total weight of examples in the batch, and the term Hzₜ is summed over values of zₜ for all examples in the batch. Note that the weights and biases leading to the neuron weights zₜ do not update between examples in the batch, but zₜ will be different between different examples in the batch. This is because different leaf nodes in each example activate different paths that result in different weight values in a layer.

Lagrange Constraint Optimization with L₂ Regularization

As shown for feature bias constraint optimization, applying the code constraint at full strength may dominate the top level objective. Therefore, L₂ regularization can be applied on the dual constraint variables to balance between the constraints and the top level objective. Adding the regularization term, the optimization becomes

$${max}_{\underline{λ}} {min}_{z} \{ {\sum }_{t} [ {L}_{t} + {\underline{λ}}^{T} ( H \cdot z - c - \frac{α}{2} {\underline{λ}}^{T} \underline{λ} ) ] \} .$$

In an online setting, this form is meaningful only over a batch of examples, designated by the example count t; t∈{1, 2, . . . , T} in the batch, where T is the size of the batch, and for convenience, examples in the batch are indexed from t=1 to t=T. The batch gradient updates become

$${\sum }_{t} \frac{\partial {\tilde{L}}_{t}}{\partial {z}_{t}} = {\sum }_{t} \frac{\partial {L}_{t}}{\partial {z}_{t}} + {TH}^{T} {\underline{λ}}_{0}$$

$${\sum }_{t} \frac{\partial {\tilde{L}}_{t}}{\partial \underline{λ}} = {\sum }_{t} {Hz}_{t} - Tc - α T {\underline{λ}}_{0}$$

where λ₀ denotes the value of the dual variable before the batch update, and zₜ are the neuron values at example t before any update on the weights of all layers are performed in the batch.

### Extensions and Discussions

In this section, some additional discussion points and potential extensions are discussed.

Energy, Learning Rates and Codes

Learning Rate:

In Error Control Coding, the general idea is to increase the dimensionality of the code vector to introduce redundancy to the code. A smaller subspace of vectors is mapped into a larger space. To keep comparison fair, the energy of a codeword is distributed among more dimensions. This implies that each dimension has less energy in average, but the improvements are achieved by increasing the distance between codewords due to the additional dimensions. The question that arises is what is the similar concept in coded-regularization? The learning rate (or its cumulative value over multiple training examples) can act as the measure of energy invested in a layer. This indicates that when more redundancy is added in the form of constraints in the parity check matrix H, the learning rate should be reduced for each of the weights leading to the neurons upon which the constraints are applied.

Balance Among Constraints and Neurons:

The actual form of H will dictate both the energy balance between different constraints (rows), and between different neurons (columns). As mentioned, for symmetry over the constraints, the rows of H can have equal energy (according to some notion L₁ or L₂ representing energy). However, in some implementations, rather than preserving such symmetry, this symmetry can be broken and some constraints can be allowed to dominate others. A similar choice can be made with respect to the balance among neurons: whether some neurons are allowed to be dominated by a constraint more than others. For the same code subspace, different H matrices can be chosen that will address these two balances differently, and can speed or slow down convergence of the network.

For example, consider the matrix

$$H = [ \begin{matrix}1 & - 1 & 0 \\ 1 & 0 & - 1 \\ 0 & 1 & - 1\end{matrix} ]$$

used earlier to describe a level of generalization of co-distillation. This matrix spans the same null space as the matrix

$${H}^{′} = [ \begin{matrix}1 & - & 0 \\ 1 & 0 & - 1\end{matrix} ]$$

However, if H is used for the constraints, more energy will be applied in total for the constraint updates than if H′ is used. In either of the cases, we have

$${H}^{T} H = [ \begin{matrix}2 & - 1 & - 1 \\ - 1 & 2 & - \\ - 1 & - 1 & 2\end{matrix} ]$$

$${H}^{′ T} {H}^{′} = [ \begin{matrix}2 & - 1 & - 1 \\ - 1 & 1 & 0 \\ - 1 & 0 & 1\end{matrix} ]$$

Using the L₂ regularization approach, with H each neuron can be updated to satisfy the constraint with effectively potentially larger update than with H′. This could be offset by the choice of λ, but different updates would still be performed.

To preserve symmetry over the row, the matrix H in the equation can be replaced by a row normalized matrix (e.g., normalized in its L₁ norm). To preserve symmetry among neurons in updates, the matrix H^{T} in the equations can be replaced by a rows normalized (column normalized on H) matrix.

### Stability and Irreproducibility

Coded-regularization can generalize on co-distillation and (possibly with some additional nodes in a layer) produce similar performance with a more reproducible and stable network. Unlike co-distillation though, it may allow training of only a single network, and potentially deployment of a single network instead of a subset of networks that still need to be deployed to preserve accuracy performance with co-distillation.

One specific aspect is the potential benefit to reduce the number of dead units in the network that are stuck at no activation when activation functions such as rectified linear units are used. The gradient for the constraints can push the dead units away from such unrecoverable state.

### LDPC and Other Codes

It has been established that many forms of code can be used. Hamming codes add a small set of constraints preserving a minimum distance between codewords. However, on reals, they will have a (potentially undesirable) property which breaks the update symmetry between the neurons. This may be mitigated by using a different real matrix that spans the same space the standard matrices span.

Minimum Distance Separable (MDS) codes can also be used for this problem. Hadamard codes based on Hadamard matrices provide large distance between codewords, but have low rates. They can be applied for imposing the constraints, but may require adding many additional neurons to the layer. Parity check matrices H that involve many neurons in one parity check may be used with a much smaller A and/or learning rate not to dominate the top level objective.

LDPC codes can be randomly constructed. Regular LDPC codes will preserve the symmetry among constraints and neurons. In error correction, construction of LDPC codes attempts to maximize the girth of the code (the minimum length of a cycle on the parity check matrix). Cycles can be viewed as harmful because of the belief propagation over a bipartite graph decoding algorithm of LDPC codes. Small cycles can create feedback from one node to itself in decoding. For coded-regularization, this is not an issue, as gradient descent is typically used for decoding. However, cycles can create correlation between neurons that are updated during the convergence period to the constraints. So, it may still be desirable to construct matrices with larger girths.

Finally, the constraints discussed so far are linear and rely on linear parity-check matrices. In some implementations, non-linear constraints can be applied on nodes in the network as well.

### Coded-Regularization and Feature Bias Constrained Optimization

Example implementations of coded-regularization are a form of constrained optimization. Specifically, the Lagrange constrained optimization approach applies a similar method to the one used for feature bias constrained optimization. Thus, coded-regularization is an approach that bridges co-distillation and constrained optimization.

There are, however, two major differences to this approach from feature bias constrained optimization:

(1) Feature bias constrained optimization imposes constraints on the training examples, whereas coded-regularization constrains the architecture of the neural network. Doing so utilizes the redundancy in the neural network pertinent to representing the training examples.

(2) Feature bias constraints, at least for logistic regression, attempt to reduce bias that asymptotically does not exist in linear models, but could exist in neural networks due to nonlinearity. In other words, the feature bias constraints attempt to fix effects generated by the neural network, and not to impose additional constraints on the network.

Both methods can complement each other, as they address different problems, both of which are beneficial to address. In addition, one could consider applying bias constraints to activations of hidden neurons in the network in addition to features at the bottom of the network. Inner nodes which are activated could be viewed as feature crosses derived on the activated nodes entering the layer. A single node can be viewed as a mix of such crosses over different sets of features for which the node is activated. Sometimes the activation can be the result of one set of child nodes, while in other times of another set for the same neuron. Thus there is reason to impose bias constraints on such crosses in addition to constraints imposed on leaf nodes. Applying the randomality idea, such feature bias example based constraints can be imposed on a (small) random subset of hidden activated nodes.

### Inter-Layer Constraints and Constraints on Activations

The description above focused on generating code constraints on the neurons of single layers, i.e., a constraint described by a linear equation is applied on a subset of neurons in a single layer. This may result in improved reproducibility and stability. However, the present disclosure is not limited to only to such constraints.

In particular, in some implementations, constraints can be applied inter layer, e.g., constraints (e.g., linear constraints) can be imposed on random sets of neurons from the neural network, regardless of the layers they belong to. Constraints can be applied not only on neurons, but also on weights or links going into neurons and biases of neurons. They can also be applied post-activation. However, this should be done carefully. A homogenous constraint applied on activations using rectified linear units where all linear coefficients are nonnegative will attempt to set all activations in the constraint to 0. Therefore, in such a case, negative coefficients can be included, or a non-homogenous constraint can be applied. In addition, constraints on activations may not be satisfied when all nodes on which the constraint is applied are not activated.

Applying linear constraints on weights entering neurons can require a larger set of constraints because of the number of such weights (square dependency in the neuron counts in layers), whereas applying the constraints on neurons can require a linear size of the set of constraints. Applying constraints on edge (link) weights can require sets for rows and columns of the weight matrices.

### Overfitting and Stability

Coded-regularization is presented above as an approach to primarily address irreproducibility in training neural networks. However, it further acts, in fact, as a way to address overparameterization of the network, which manifests itself by overfitting to the training data and poor generalization. Thus, coded-regularization will address overfitting and stability in training neural networks, and result in better generalization of the network on unseen data.

### Rateless Codes

A special family of codes in error control coding are rateless codes (including Raptor codes and others). These are codes that were developed mainly for an unknown erasure channel, but can also be used for other channels. The erasure channel is a channel in which with some probability some symbols that are transmitted are not received at their destination. Erasure channels are common in computer networks, where the message is sent in packets. If a packet is lost, an erasure has occurred.

Specifically, these codes are useful in communication networks, and broadcast type channels. A broadcast channel is one where a single transmitter sends messages to be received by multiple receivers. The channels to different receivers may have different statistical properties. Some receivers may have high packet loss rates, while others may have lower loss rates. The idea is to create a code that can generate multiple parity symbols. All the symbols are sent by the transmitter, e.g., in a broadcast type channel. Each receiver that attempts to decode the message processes as many of the received symbols as it needs to reliably decode the message.

For coded-regularization, the relation to rateless codes is motivated by the following: The constraints applied attempt to adapt a network layer to the rate of information in the layer. In other words, the training tries to direct the redundancy already in the layer such that it satisfies the constraints. In some implementations, it may be desirable to impose as many constraints as possible, so that the network is reproducible, but no information that is in the layer is lost. If too few constraints are imposed, all of the ability to improve reproducibility and potentially reduce overfitting due to overparameterization is not utilized. If too many constraints are imposed, however, underfitting may occur by forcing the layer to learn less information than it needs. To address this balance, the concept of rateless codes can be used. In this setting, example implementations of the present disclosure will impose as many constraints as are needed for the data the layer is training, not less and not more.

One example method that can be used to apply a rateless coding approach is as following: example implementations of the present disclosure start with a few constraints, i.e., the first few rows of a layer parity check matrix. Once they are all satisfied in training, more constraints are gradually added, assuming there may be more redundancy in the network. Example implementations of the present disclosure can use some very small threshold on the constraint error to determine that a constraint is satisfied. If all constraints currently applied are satisfied with an error that is smaller than the threshold, the system can move on to adding more constraints. On the other hand, to prevent underfitting, example implementations of the present disclosure can also measure the overall loss error over windows of time. If by adding more constraints, it is observed that the overall error increases, the most recently added constraints in training can then be removed.

Example implementations of the present disclosure can determine that some point is an equilibrium, and no more constraints are needed once it is observed that every attempt to add constraints degrades the overall training error. To ensure that the process does not favor overfitting by removing constraints, example implementations of the present disclosure can use validation error on unseen test data as a test of whether an additional constraint was helpful or harmful, and not the training error. Every several training batches with the current set of constraints, a validation round can be run on test data to measure the performance, and the system can proceed accordingly. Alternatively, in an online regime, this can be done with progressive validation on the next batch of training examples.

While these example techniques resemble rateless codes, they are, in fact, a slightly different approach to rateless codes. For rateless codes, example implementations of the present disclosure can add more parity symbols to the codewords making the code vector longer. However, alternative example implementations of the present disclosure do not change the code vector length, but instead shift components of the vector from information nodes to parity nodes, without increasing the code vector length.

Overall, both approaches lower the rate of the code (i.e., the ratio between the length of information sequence and that of the coded sequence). Standard rateless codes achieve this by increasing the length of the denominator in the ratio, while for coded regularization with rateless codes example implementations of the present disclosure achieve this by decreasing the numerator. Unlike rateless codes that add parities as additional code symbols, some example implementations of the present disclosure add a parity at the expense of an information symbol.

### Lattice and Modulation Codes

Classical error control codes are designed over finite fields (i.e., with a finite set of valid symbols as components of the code vector). For coded-regularization, the constraints are imposed on vectors whose values are real numbers. While classical methods can be used, it can be more natural to use codes designed for reals. Such a code family is that of lattice codes. Lattice codes consider placing the codewords as vectors in the Euclidean space. There are still notions like syndrome that can be used for decoding of lattice codes, including quantization to integer values. For coded-regularization, imposing the constraints with lattice codes may be a natural approach for work in the Euclidean space.

Hardware implementations of neural networks often quantize the parameters into fixed precision with a fixed number of bits. Using lattice codes, aspects of the present disclosure can constrain the nodes of the layer to be coded into valid fixed precision points. This will reduce the error due to quantization. It may be more natural to do when constraints are applied on the actual parameters (e.g., link, weights, and biases) instead of neuron or neuron activations. The constraints can shift the redundancy already in the network towards a valid lattice point which is implementable in the hardware version. It is, of course, possible that we may not be able to fully satisfy these constraints, but we can certainly guarantee improved error when we quantize by forcing the network to converge towards parameters that do satisfy these constraints. Note that lattice constraints on quantized values can be also used with training of quantized neural networks, where the constraints can apply to a subspace of the quantized space, the gradients are computed with the quantized weight values, but the actual weights at training take an unquantized currently learned value.

Another direction of coding that can be applied here are modulation codes—modulation codes are codes that essentially place the signal in a Euclidean space representing mathematical functions used for sending a signal over the channel. Modulation codes are constructed to ensure code points are as distant from one another as possible. However, imposing constraints for modulation codes is more complex. Modulation is also done without direct coding. Constraints can still be imposed on the distance of a layer vector to its modulation point.

### Randomized Parity Matrices

Another approach to break symmetry in the neural network and also apply real number constraints is to construct a classical parity check matrix over a finite field initially, but then multiply the matrix elements by random numbers (e.g., a standard normal distribution). This approach can lead to breaking the symmetry among neurons in a layer. If negative values are allowed, example implementations of the present disclosure can also apply the constraints on activations instead of pre-activations. A further approach can add a random noise value to nonzero entries in the parity matrix.

### Cyclic Codes

Because there is no reason for neurons to be ordered in a certain way in a layer (i.e., pure permutations should not affect overfitting, reproducibility or stability), codes that break other types of symmetry, but not permutation symmetry, may be a good choice of codes. In other words, valid codewords can be permutations of other codewords. Such a design can address the issues identified herein, but need not address harmless permutation. Thus, the family of cyclic error correcting codes (e.g., BHC codes) can be used for coded-regularization as well.

For cyclic codes, each cyclic rotation of a codeword is also a codeword. Such a structure has potentially desirable symmetry properties, but still gives the advantage of good separability of codewords which are distant from each other. The family of BCH codes has very good properties of spacing codewords over the code space, especially for smaller layers (256 or less neurons). BCH codes are as good as state of the art codes for short block lengths like these. For longer blocks, LDPC codes may be better.

### Code Minimum Distance

In error control coding, the minimum distance between codewords is a key factor in the performance of the code due to the exponential decay of the error as function of the distance. It does not change the richness of the code in terms of the total number of codewords, but with larger minimum distance, these codewords are better separated and the two nearest ones are farther apart. Standard codes are designed with Hamming distance, which together with modulating the signal results in improving the Euclidean distance between valid codewords. Using classical finite fields techniques that improve minimum Hamming distance will carry over to better separation of the codewords in Euclidean space. Note that using error control codes with bad (small) minimum distance will produce the same dimensionality of a code that has large (good) minimum distance.

However, in some implementations, it is important to have codewords as far as possible from one another for better separation of optima from other possible local optima. This requirement differentiates using error control codes to improve neural networks' performance from other techniques that attempt to enforces structure on the layers. Here, we enforce structure, but a specific structure that ensures that it is hard to move from one valid layer vector to another. This also implies that having a good code with large minimum distance is important, and therefore a good code design can improve performance.

### Coded-Co-Distillation

A first extension of co-distillation into coded-regularization can have two (or more) separate network towers, that meet at the top, each producing its own output loss, but the two are connected through a set of parity constraints on their top hidden layer. This structure can be referred to as Coded-Co-Distillation. A +1/−1 constraint can also be applied on the top layer, i.e., one tower's output or pre-activation equals that of the other tower (co-distillation) in addition to the constraints of the top hidden layer.

A simple constraint to apply on the top hidden layer is having the nodes of the hidden layer of the first tower constrained with +1 and those of the other tower with −1, i.e., we constrain that the sum of the nodes in one tower equals that of the other tower.

However, more complex constraints can also be applied to (a) force the nodes of each tower to converge to different values, but the overall losses to the same, and (b) to increase the minimum distance between codewords. For example, one node from the top hidden layer of one tower can equal the sum of two nodes from the top layer of the other tower.

Coded-Co-Distillation can be performed with more towers. If additional towers are not expected to improve on the accuracy beyond mitigating overfitting, this may mean that we do not expect new information to be added by additional towers. That is, the sole purpose of additional towers can be to mitigate overfitting, and as such they do over-parameterize the network if they are not constrained to be tied to the other towers. If that is the case, strong low-rate codes can be applied on the layers, like Hadamard codes. For modulation codes, it is possible to impose constraints through a transform space, like the Fourier transform of the layer.

One should be careful not to impose impossible constraints between layers. However, some conflicting constraints between different components of a layer in different sub-towers may be good for diversifying well between the towers internally. For example, forcing a node in one tower to sum to 0 with a node with a different tower will require them to reverse signs. Forcing a node in one tower to sum to 0 with two nodes in the other, will break symmetry even better (not just in the sign). Such constraints will propagate up to the top of the towers and will diversity one tower from the other.

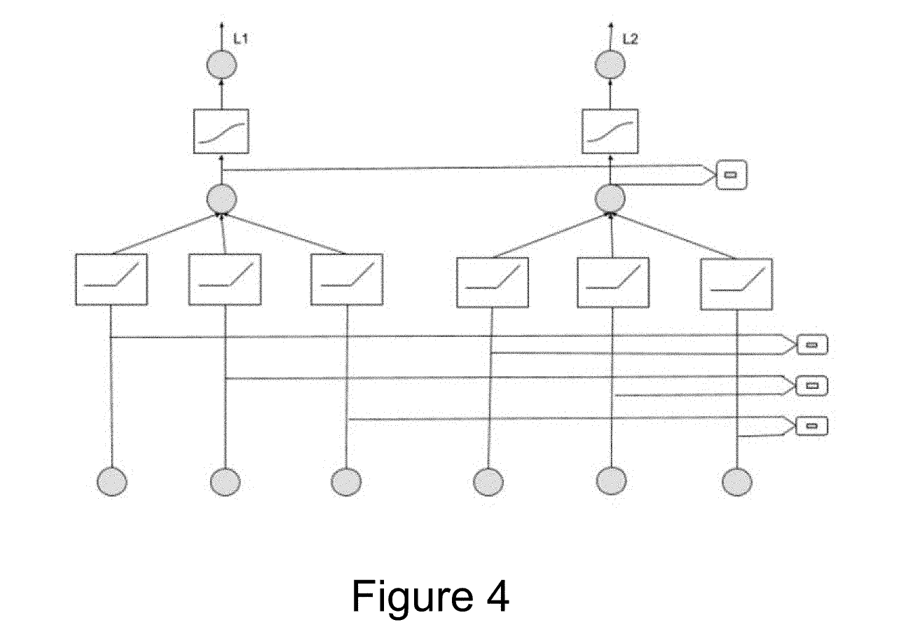

FIG. 4 illustrates a simple example of coded-co-distillation where the top activations are constrained to be equal as in co-distillation, and the top hidden layer is constrained by the following parity check matrix:

$$H = [ \begin{matrix}1 & 0 & 0 & - 1 & 0 & 0 \\ 0 & 1 & 0 & 0 & - 1 & 0 \\ 0 & 0 & 1 & 0 & 0 & - 1\end{matrix} ]$$

### Separate Towers or Tower Tops Connected in Parity

A next step to generalize co-distillation is creating several components of the network that are separate at the top layer(s), but connected in or share bottom layers (closer to the input). The key idea, however, is that such separate towers are still connected with parity check constraints within each layer, including layers in which they are not connected through the tower.

One possible example structure can include splitting each tower of the two towers into two sets, and then each separate top layer of two different towers is linked to only subsets of the four sets (16 maximal combinations of subsets on which an extended (16,11) Hamming code can be applied. This idea can be generalized recursively.

### Puncturing

In a fully connected network constraining the neurons pre-activation can lead to a solution in which the links out of all neurons in the next layer down follow the same constraints. More precisely, suppose a constraint in imposed on layer ‘a’ pre-activation. Then, the constraint can be satisfied by imposing the same constraint on the weights on the links out of each neuron in layer a−1 connected to layer a. Such a solution may not propagate the constraint down to the layers below. The nonlinearities on the neurons at layer a, however, may break this symmetry, as some combinations of such activations may lead to some neurons being deactivated.

Having such solutions may still limit the effect of the constraints below the layer on which they are imposed. One way to break such symmetries is to puncture some links in the network. Example implementations of the present disclosure can randomly puncture a fraction of the links between different layers. The puncturing will break this symmetry and ensure that a solution to the constraints in which the links follow the layer constraints is impossible. Puncturing may potentially generate an effect like that of having separate tower components.

In some implementations, puncturing can be done once to change the topology of the network, and all training and deployment can be done with the punctured network. Alternatively, links can be dropped during training, differently per each example or batch, like drop-out discussed below.

### Training Examples Drop Out and Interleaving

One of the design advantages in turbo codes is achieved by the shuffling of the data sequence prior to performing encoding in the second component code (interleaving of the data). This leads the code to increase its effective distance between different code words.

In some implementations, a similar effect can be generated by performing drop out of examples in the following manner. Suppose we start with a coded-co-distillation structure of two towers. Then, the network is trained with two loss outputs, one for each tower. However, examples are either seen by both towers, or one or the other towers. One possible schedule could be round robin three different types of training examples:

(1) Seen by both tower heads;

(2) Seen by left tower head;

(3) Seen by right tower head.

At each step the example loss is trained only by the designated head or heads of the tower. Back-propagation, however, is performed on the complete network, where the constraints loss is propagated at each step, but the objective loss is only propagated from the tower heads that see the example.

If we are limited in training examples, we can randomly interleave the examples not seen by a given tower at a given training instance and store them in memory in random order, and then randomly pick them to train on the tower that has not yet trained on them.

These two modifications can potentially achieve additional distance between the effectively constrained codewords strengthening coded regularization by diversifying the code across the training example space.

### Batch Normalization

A form of batch weight normalization can be enforced by an all 1 parity check matrix row. To enforce a constraint that resembles batch weight normalization, we can enforce the sum of this check to equal 1. This approach resembles batch normalization but is still different. Batch normalization is aggregated over examples to enforce the standard deviation over the examples to be normalized. It is also done in link level (on links entering a neuron from the layer below), and not on other layer components. However, there is a direct connection between the all 1 parity row and batch weight normalization.

### Breaking Path Symmetry

One of the purposes of imposing a code is to break path symmetry. A constraint that the sum of two neurons should be 0 forces one to be positive and the other to be negative. With ReLU activations, this means that for some examples, one neuron will be on, while the other off, but depending on the examples, the reverse can happen. Such constraints with the non-symmetry essentially impose path diversity between examples, which can improve the neural network.

### Ensembles of Smaller Networks

Designs such as the Coded-Co-Distillation may allow training ensembles of many smaller networks, which may be parallelized better (although they would still require the layer constraints to be satisfied at least at some layers).

In another example, many sparser connections can be included (e.g., instead of one matrix of n×n weights, we can have m matrices of k×k nodes where k is much smaller than n). The constraints may still impose propagation among the different sub-networks that can propagate the information in the full network. This can enable achieving identical performance with much lower complexity, and potentially improving overfitting and reproducibility of the network.

### Location of Constraints

As discussed above, it is somewhat natural to impose the constraints pre-activation on the neurons. However, this is not necessarily the only method. It allows equating the dot product of the constraint matrix with the neuron weights to 0. Imposing constraints on post-activations may be more restrictive with some activations. For example, using ReLU, it is difficult to impose a constraint with a parity matrix of all nonnegative values equating the dot product to 0. Instead, as examples, we can use one of two example methods:

(1) Impose a constraint that the linear combination sums to a positive number (for example, 1).

(2) Randomly perturb the nonzero elements in each two between 1 and −1, making sure some are positive and some are negative and avoiding the unlikely case that all will have the same sign.

Both these approaches can naturally combine with random perturbation of the actual check matrix entries, discussed earlier.

### Real Error Control for Unreliable Storage

There are other benefits provided by coded-regularization. One particular advantage is that the code can be utilized on layer nodes for actual error correction in noisy channels. For example, consider the case where the weights of the neural network are stored on an unreliable storage medium. When deploying the weights in memory, error correction can be employed to ensure that the layers of the network satisfy the constraints before using the network for prediction, classification or any other task. This is possible because coded-regularization diverts the redundancy already in the network to structured form that can be used for channel decoding against unreliable storage or transmission.

In a recent work, it was shown that losses in the network are not large with a small fraction of the weights being corrupted by unreliable storage or transmission. This extends on additional research that shows that neural networks do suppress noise in a layer. Coded regularization can be used to improve on that capability beyond the natural uncontrolled redundancy already in the network.

### Example Devices and Systems

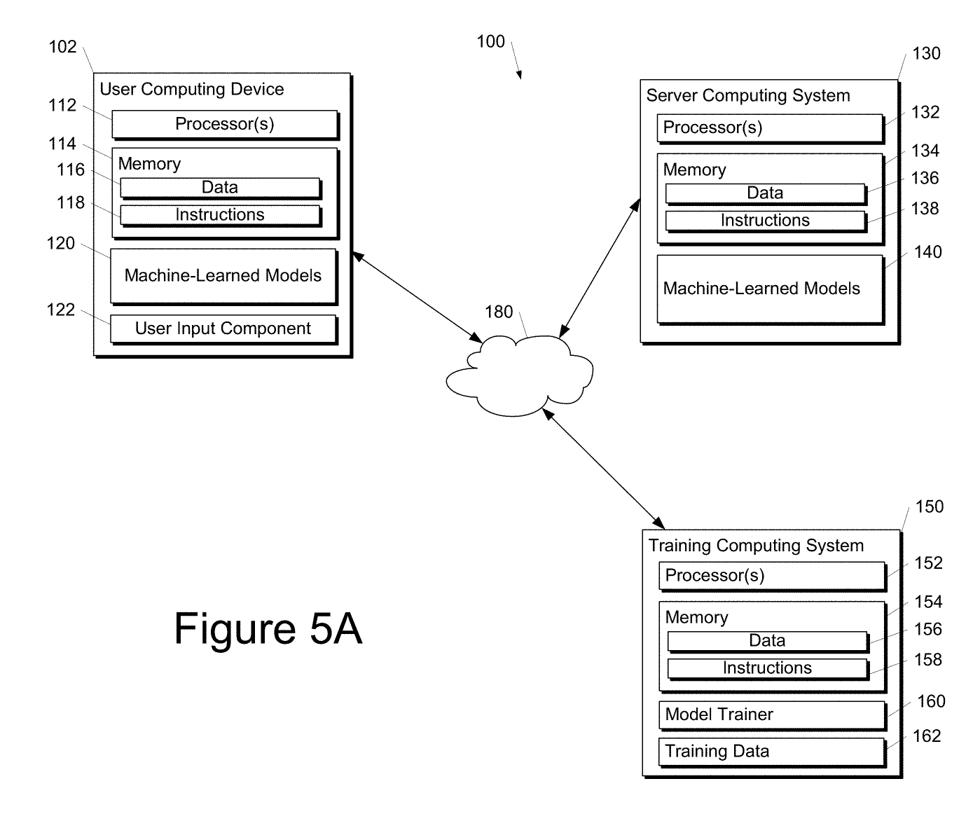

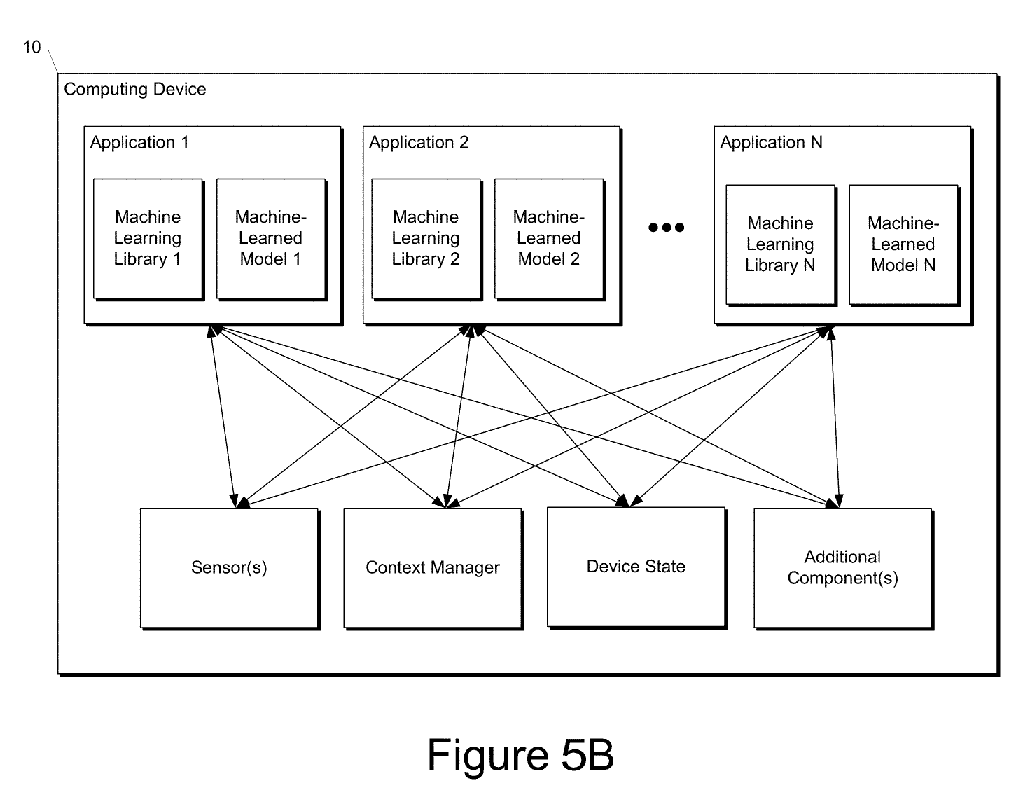

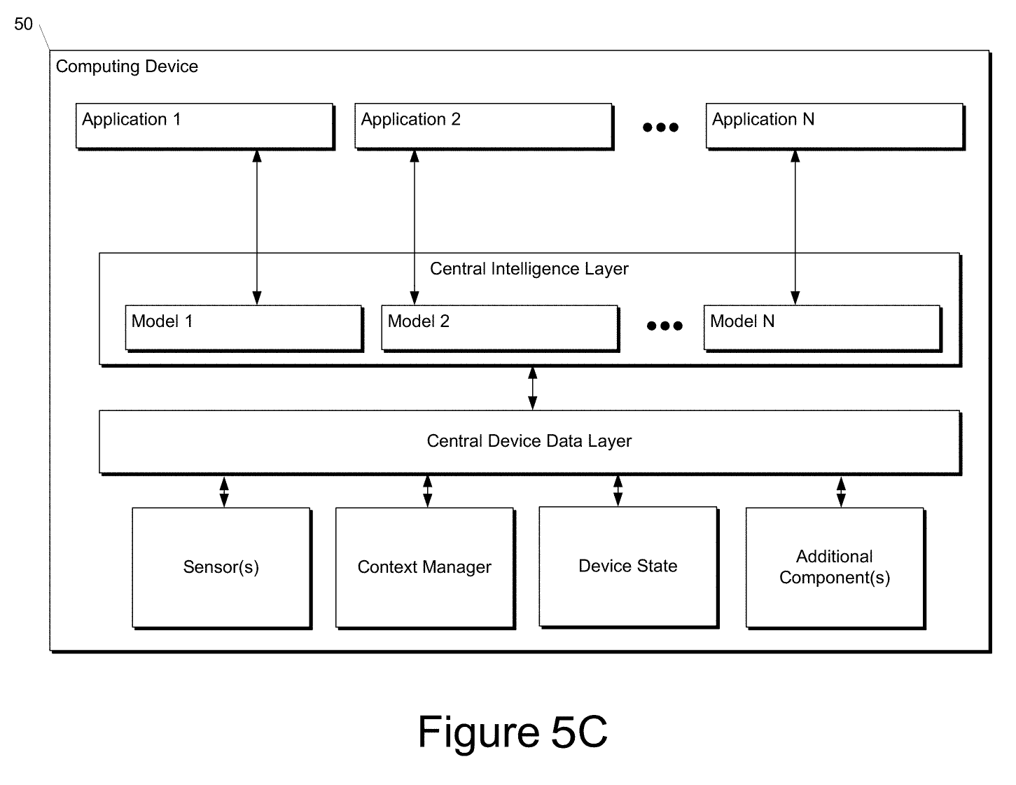

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The model trainer 160 can perform any of the coded-regularization techniques described herein.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to train neural networks, the method comprising:
obtaining, by one or more computing devices, data descriptive of a neural network;
evaluating, by the one or more computing devices, a loss function that is descriptive of a performance of the neural network with respect to a set of training examples; and
backpropagating, by the one or more computing devices, the loss function through the neural network to train the neural network, wherein backpropagating, by the one or more computing devices, the loss function through the neural network comprises, for one or more neurons, links, or biases of the neural network:
determining, by the one or more computing devices, a gradient of the loss function with respect to the one or more neurons, links, or biases of the neural network, wherein, for at least the one or more neurons, links, or biases, the loss function includes an additional loss term that penalizes non-adherence of the one or more neurons, links, or biases to one or more code constraints; and
modifying, by the one or more computing devices, the one or more neurons, links, or biases of the neural network based at least in part on the gradient of the loss function with respect to the one or more neurons, links, or biases.

2. The computer-implemented method of claim 1, wherein the one or more code constraints comprise a set of equations on values produced by the one or more neurons, links, or biases, wherein the set of equations comprises linear equations, non-linear equations, or both linear and non-linear equations.

3. The computer-implemented method of claim 2, wherein the set of equations comprise a set of parity check equations.

4. The computer-implemented method of claim 1, wherein the one or more code constraints comprise one or more error control code constraints, one or more modulation constraints, or one or more lattice code constraints.

5. The computer-implemented method of claim 1, wherein:
the one or more neurons, links, or biases comprise a plurality of neurons included in a layer of the neural network; and
the additional loss term provides a penalty based at least in part on a magnitude of a syndrome, wherein the magnitude of the syndrome is based at least in part on a dot product of a neuron vector or link or bias vector produced by the layer and a parity-check matrix.

6. The computer-implemented method of claim 1, wherein:
the one or more neurons, links, or biases comprise a plurality of neurons included in a layer of the neural network; and
the additional loss term provides a penalty based at least in part on a magnitude of a syndrome computed for the layer, wherein the magnitude of the syndrome is equal to a dot product of a neuron vector produced by the layer and a parity-check matrix minus a bias vector.

7. The computer-implemented method of claim 1, wherein the additional loss term comprises the square error of the one or more code constraints to a composite loss.

8. The computer-implemented method of claim 1, wherein modifying, by the one or more computing devices, the one or more neurons, links, or biases of the neural network based at least in part on the gradient of the loss function comprises modifying, by the one or more computing devices, the one or more neurons, links, or biases of the neural network based at least in part on the gradient of the loss function to minimize a loss provided by the loss function with respect to one or more neurons in the layer but to maximize the loss with respect to a multiplier dual variable vector.

9. A computing system comprising:
one or more processors; and
one or more non-transitory computer-readable media that store instructions that, when executed by the one or more processors, cause the computing system to perform operations, the operations comprising:
obtaining data descriptive of a neural network; and
training the neural network based on a training dataset, wherein training the neural network comprises injecting a gradient of an additional loss term into the neural network during backpropagation of a loss function through the neural network, wherein the additional loss term penalizes non-adherence of two or more neurons or parameters of the neural network to one or more code constraints.

10. The computing system of claim 9, wherein the one or more code constraints comprise one or more error correcting codes, modulation codes, or lattice codes that constrain the two or more neurons or parameters of the neural network.

11. The computing system of claim 9, wherein the one or more code constraints comprise parity constraints applied to the two or more neurons or parameters of the neural network, wherein the parity constraints sum to zero or another real number.

12. The computing system of claim 9, wherein the one or more code constraints comprise one or more rateless code constraints.

13. The computing system of claim 9, wherein the two or more neurons or parameters to which the one or more constraints are applied are located in a same single hidden layer of the neural network.

14. The computing system of claim 9, wherein the two or more neurons or parameters to which the one or more constraints are applied are located in two or more different hidden layers of the neural network.

15. The computing system of claim 9, wherein injecting the gradient of the additional loss term during backpropagation comprises treating the additional loss term as a regularization term for the loss function or performing Lagrangian constrained optimization.

16. The computing system of claim 9, wherein injecting the gradient of the additional loss term comprises: determining a syndrome based on a code parity check matrix associated with the one or more code constraints; and determining the gradient of the additional loss term based at least in part on the syndrome.

17. The computing system of claim 9, wherein the one or more code constraints comprise one or more of:
block code constraints;
convolutional code constraints;
cyclic code constraints;
quasi-cyclic code constraints;
lattice or real number valued code constraints
Hamming code constraints;
Hadamard code constraints;
BCH code constraints;
LDPC code constraints;
turbo code constraints;
LDGM code constraints;
HDPC code constraints;
Reed-Solomon code constraints;
Reed-Muller code constraints;
CRC code constraints;
Golay code constraints; or
Polar code constraints.

18. The computing system of claim 9, wherein the additional loss term penalizes non-adherence of two or more neurons or parameters respectively included in two or more different neural networks to the one or more code constraints.

19. The computing system of claim 9, wherein the neural network comprises an input embedding layer that receives an input embedding, and wherein the two or more neurons or parameters to which the one or more code constraints are applied are included in the input embedding layer.

20. The computing system of claim 9, wherein the operations further comprise puncturing one or more links of the neural network to break symmetry of the two or more neurons or parameters.

21. The computing system of claim 9, wherein training the neural network further comprises dropping out or shuffling training examples from the training dataset between components of the network or separate networks trained together.

22. The computing system of claim 9, wherein the two or more neurons or parameters of the neural network comprise two or more neurons of a hidden layer of the neural network, wherein the one or more code constraints are applied to the two or more neurons pre-activation or post-activation.

23. The computing system of claim 9, wherein the operations further comprise applying error correction to enforce one or more additional code constraints on the neural network when:
combining a plurality of versions of the neural network trained in parallel; or
retrieving the neural network from a storage device.

24. One or more non-transitory computer-readable media that store instructions that, when executed by one or more processors, cause the one or more processors to perform operations, the operations comprising:
obtaining data descriptive of a neural network, the neural network comprises a plurality of layers of neurons;
evaluating a loss function that is descriptive of a performance of the neural network with respect to a set of training examples; and
backpropagating the loss function through the neural network to train the neural network, wherein backpropagating the loss function through the neural network comprises, for each of one or more hidden layers of the plurality of layers of the neural network:
determining a gradient the loss function with respect to one or more network parameters included in the layer, wherein, for at least the layer, the loss function includes an additional loss term that penalizes non-adherence of the layer to one or more code constraints; and
modifying the one or more network parameters included in the layer based at least in part on the gradient of the loss function.
